(19) United States
(12) Patent Application Publication
(10) Pub. No.: US 2006/0049631 A1
(43) Pub. Date: Mar. 9, 2006

(54) Pipe connection for pipe pieces made of plastic

(76) Inventor: Pieter Tolhoek, Schilde (BE)

Correspondence Address: BROOKS KUSHMAN P.C., 1000 TOWN CENTER, TWENTY-SECOND FLOOR, SOUTHFIELD, MI, 48075, US

(21) Appl. No.: 10/512,701

(22) PCT Filed: Apr. 25, 2003
(86) PCT No.: PCT/NL03/00312

§ 371 Date: Jul. 15, 2005

(30) Foreign Application Priority Data
Apr. 26, 2002 (NL) 1020494

(51) Int. Cl. F16L 17/00

(52) U.S. Cl. 285/374

(57) ABSTRACT

The invention relates to a pipe connection for mutually connecting two pipe pieces made from fibre-reinforced plastic, comprising: an external screw thread arranged on a male end of a first pipe piece, an internal screw thread arranged on a female end of a second pipe piece and fitting onto the external screw thread, and a substantially annular cavity which is placed between the screwed together pipe pieces and which is suitable for filling with a sealing material, wherein the cavity is filled with a solid material.

The invention relates to a pipe connection for mutually connecting two pipe pieces made from fibre-reinforced plastic, comprising: an external screw thread arranged on a male end of a first pipe piece, an internal screw thread arranged on a female end of a second pipe piece and fitting onto the external screw thread, and a substantially annular cavity which is placed between the screwed together pipe pieces and which is suitable for filling with a sealing material, wherein the cavity is filled with a solid material.

Such a pipe connection is known from JP-A-10153281.

Such pipe connections are usually applied for transport of gas and oil, while they are also applied in the chemical and petrochemical industry. Plastic pipes have the advantage that even in corrosive environments they are not subject to corrosion, whereby their lifespan is considerably longer than that of steel pipes.

Heretofore it has only been possible to use such plastic pipes to transport fluids under low pressures. Although the pipe pieces are per se suitable for transporting fluids under high pressures, certainly when they are reinforced with fibres, problems occur in the manufacture of the seals between the pipe pieces.

The construction shown in the above stated literature reference makes use of a groove in which is arranged a sealing ring made from deformable material. This annular groove is however arranged on the outward directed side of the screw thread. As a consequence hereof, the seal placed in this groove is subjected to the influences of the environment.

The object of the invention is to provide such a connection, wherein the sealing ring is not subjected to environmental influences.

This object is achieved in that the cavity is arranged on the inward directed end of the screw thread.

A preferred embodiment teaches that the annular cavity is placed connecting onto the screw thread. The result of this measure is that when the screw threads are screwed together the glue or plastic is compressed in the cavity so that the quality of the seal is improved.

According to a specific preferred embodiment the screw thread has on the outside a rounded profile and on the inside a right-angled profile. The advantages of both profiles, an easy screwing-in and a strong closure, are hereby combined.

By choosing a correct geometry it has become possible to tighten the screw thread connection with a very short rotation, between a half and three-quarter rotation. It has been found that there is a relation between apex angle of the cone, the profile height, the diameter of the pipe piece and the number of threads in the screw thread.

An attempt is made here to arrive at a situation in which the length of the screw thread is long in respect of the usually high pressures against which sealing must take place, but wherein a connection can be made with the shortest possible turn.

The use of a conical screw thread with an apex angle smaller than 0.1°, a diameter between 25 mm and 600 mm, a profile depth of the screw thread between 6 mm and 16 mm, preferably 10 mm, and a four-thread screw thread is found to satisfy the above stated requirements.

A specific advantage of a four-thread screw thread is the fact that it is possible to make a coupling over an angle of 0°, 90°, 180° or 270°, this being important in the case of couplings with elbow fittings.

Apart from this advantage, it is otherwise possible to make use of multi-thread screw thread with a different number of threads.

A specific preferred embodiment provides the measure that the cavity is filled with an initially liquid, and then cured material.

A solid material is understood to mean a material which is not compressible, or only compressible to an extremely small extent. A greatly improved seal is hereby obtained so that diffusion is avoided, and a mechanical strength is obtained such that the connection can withstand calamities.

It will be apparent that, in order to obtain a good seal, such a solid material must be manufactured extremely accurately with minimal tolerances. This has a cost-increasing effect.

So as to nevertheless obtain such a good seal of a solid material which can be manufactured at lower cost, a preferred embodiment teaches that the cavity is filled with an initially liquid, and then cured material.

It is important here that the material only cures when the pipe connection is obtained.

Another preferred embodiment teaches that the external and internal screw thread are connected by a glue layer, and that the cavity is filled with the glue with which the screw thread is connected.

Application of glue in the screw thread results in the first place in an improved sealing of the screw thread, but also contributes toward a greater mechanical strength. Using this same material to make the seal in the groove results in a simplification of the operations for making the connection, since only one material need be applied.

When the cavity is filled with the same type of plastic from which the pipe pieces are manufactured, a good adhesion to the pipe pieces is obtained so that the mechanical loading capacity and the sealing are greatly improved.

Instead of arranging an initially liquid sealing ring, it is likewise possible to arrange a sealing ring directly in solid form. This does after all result in a simpler method during connecting. It is herein also possible to connect the sealing ring by means of glue to one or both of the parts. The glue is in any case necessary for mutual connection of the pipe pieces.

Other attractive preferred embodiments are stated in the remaining claims. The present invention will be elucidated hereinbelow with reference to the annexed figures, in which:

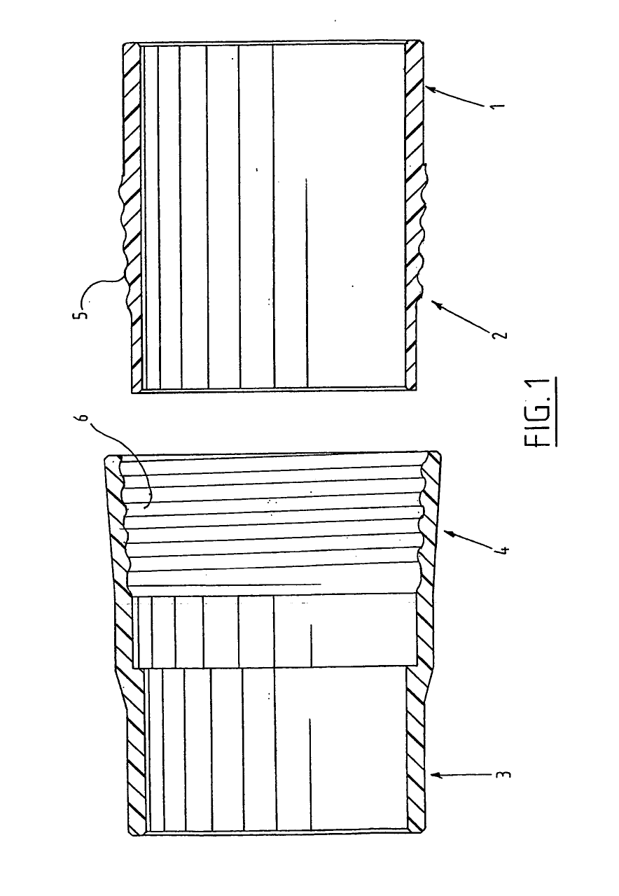

FIG. 1 shows a cross-sectional view of pipe pieces to be joined together to form a pipe connection;

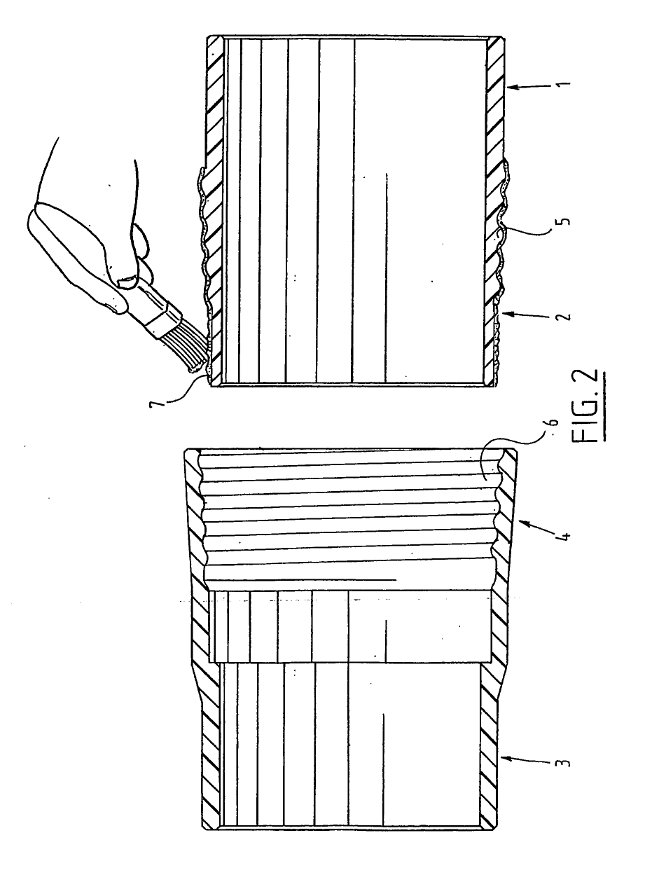

FIG. 2 shows a cross-sectional view corresponding with FIG. 1 during applying of glue;

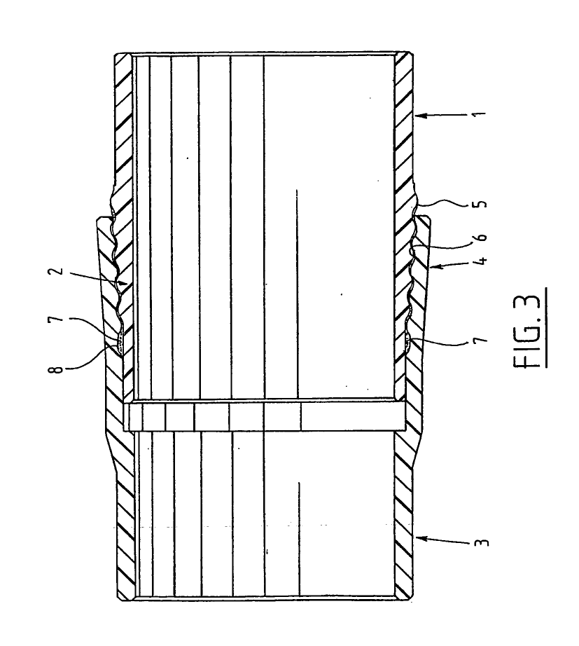

FIG. 3 shows a cross-sectional view corresponding with FIGS. 1 and 2 during screwing together of the pipe pieces;

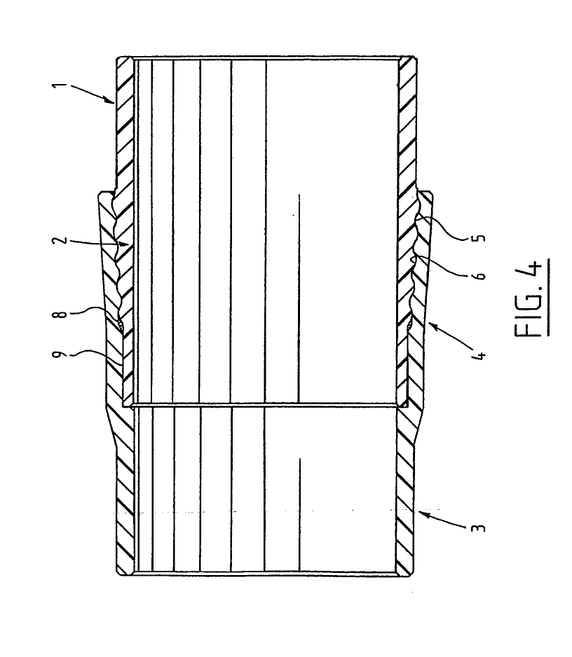

FIG. 4 shows a cross-sectional view corresponding with FIGS. 1, 2 and 3 of the completion of the pipe connection;

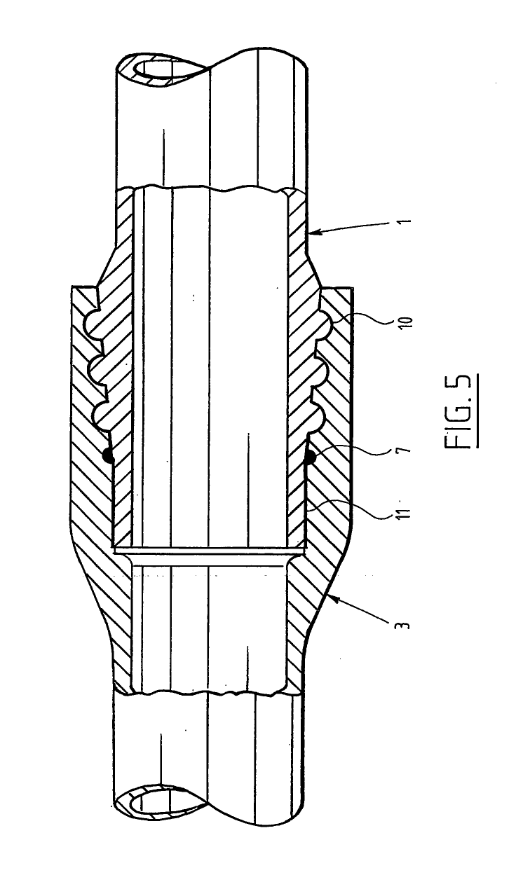

FIG. 5 shows a cross-sectional view of a first alternative embodiment of the invention; and

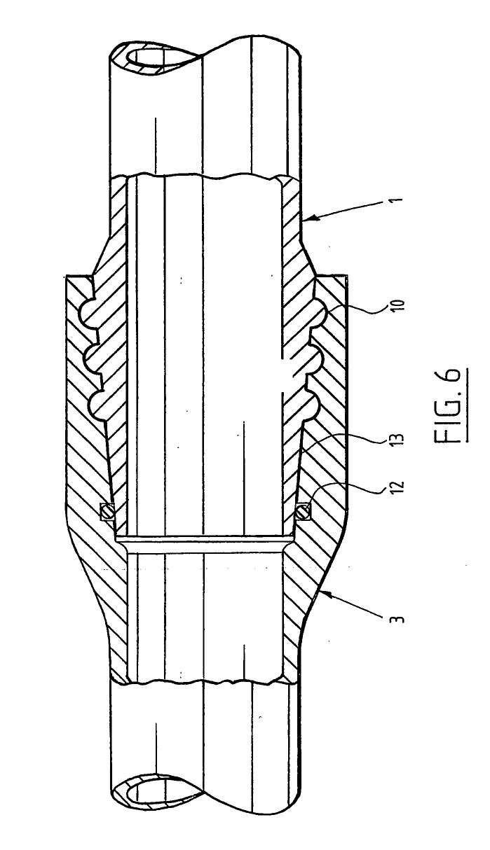

FIG. 6 shows a cross-sectional view of a second alternative embodiment of the invention.

The pipe connection is formed by a pipe piece 1 with a male end 2 and a pipe piece 3 with a female end 4. Both pipe pieces 1, 3 are manufactured from a fibre-reinforced plastic, preferably from epoxy resin reinforced with glass fibres.

Although only short pipe pieces are shown in this figure, it will be apparent that the pipe pieces will generally be longer so as to construct a long pipeline. A pipe piece will therefore have a male part 2 on one side and a female part 4 on the other side. The invention is also applicable to other shapes of pipe piece, such as elbows, T-pieces and the like.

An external screw thread 5 is arranged on the male part 2 of pipe piece 1. This is a conical screw thread with a round profile. In the female end 4 the pipe piece 3 is widened in order to receive the male part 2. The female part is further provided with an internal screw thread 6 which is likewise conical and likewise has a round profile.

The external screw thread 5 fits into internal screw thread 6. It is pointed out here that both screw threads 5, 6 have a describing cone with a half apex angle of 0.6°. In addition, the profile height of the round screw thread is 2 mm. With this combination of dimensioning factors it is possible with only a small number of rotations to obtain a fixed screw thread connection; the one pipe piece can in any case already be inserted a considerable distance into the other before the screw thread parts make mutual contact. When the screw thread is tightened however, a connection is still obtained which extends over the whole of the screw thread.

In combination with the above mentioned dimensioning measures it is attractive if the number of threads of the screw thread amounts to about six; the advantages are hereby optimized.

In order to form a connection a glue layer 7 is applied to the outside of male part 2 of pipe piece 1, as shown in FIG. 2.

As shown in FIG. 3, the one pipe piece is then inserted as far as possible into the other. Once the two pipe pieces make contact, at least one of the two pipe pieces is then rotated in the direction of the screw thread, wherein the screw thread will engage.

The situation as shown in FIG. 3 is then obtained. As can be seen in FIG. 3, the glue layer 7 will not only spread over the screw thread, but will also move to an annular cavity 8. This is the annular cavity which fulfils an important function in sealing the coupling of the two pipe pieces.

Finally, pipe pieces 1, 3 are tightened fixedly with the prescribed torque, whereafter the situation shown in FIG. 4 is obtained. Almost all the glue has here been pressed away between the screw thread and there is only glue present in cavity 8. It will be apparent that the rest of the glue has been displaced to the outside and has also been displaced partially to the seam 9 between the two pipe pieces.

The pipe connection must then be cured which, depending on the type of glue applied, can take place by polymerization as a result of heating or by evaporation of a solvent.

In the above described embodiment the annular cavity is arranged connecting directly onto the screw thread in the male part.

FIG. 5 shows an alternative embodiment which is distinguished from the connections shown in the foregoing figures by providing a screw thread 10 which is right-angled on the inside and round on the outside. Tightening is hereby facilitated, while the angle of rotation between the loose and fixed position is also greatly reduced, which saves work when the connection is made. It is pointed out here that the apex angle of the describing cone of the screw thread also plays a part here, as does the ratio of the thread height and the diameter.

A second difference lies in the fact that there follows a cylindrical part 11 connecting onto the conical screw thread 10. This has the result that a better guiding is created during insertion and that a longer distance for the seal is obtained.

Finally, FIG. 6 shows an embodiment wherein an initially solid sealing ring 12: is applied, i.e. not one which polymerizes after joining together of the connecting parts. Use is of course made of a glue to make a mechanical connection between pipe pieces 1 and 3. This glue of course also has a sealing action. As in the previous embodiment, a smooth part is applied here. It is hereby possible to form a long sealing distance, as in the previous embodiment. In the present embodiment this is however conical instead of cylindrical. The already initially solid ring 12 is herein placed on the inner side of the sealing distance 13 so as to disrupt the displacement of the glue as little as possible.

1. Pipe connection for mutually connecting two pipe pieces made from fibre-reinforced plastic, comprising:
an external screw thread arranged on a male end of a first pipe piece,
an internal screw thread arranged on a female end of a second pipe piece and fitting onto the external screw thread, and
a substantially annular cavity which is placed between the screwed-together pipe pieces and which is suitable for filling with a sealing material, wherein the cavity is filled with a solid material, wherein the cavity is arranged on the inward directed end of the screw thread characterized in that the cavity is filled with an initially liquid and then cured material.

2. Pipe connection as claimed in claim 1, characterized in that the external and the internal screw thread are connected by a glue layer and that the cavity is filled with the glue with which the screw thread is connected.

3. Pipe connection as claimed in claim 1 or 2, characterized in that the cavity is filled with the same type of plastic from which the pipe pieces are manufactured.

4. Pipe connection am claimed in claim 1, characterized in that the annular cavity is placed connecting onto the screw thread.

5. Pipe connection as claimed in claim 1, characterized in that the screw thread of the two pipe pieces has an at least partially rounded profile.

6. Pipe connection as claimed in claim 1, characterized in that the screw thread of the two pipe pieces is conical.

7. Pipe connection as claimed in claim 6, characterized in that the half apex angle of the describing cone of the conical screw thread amounts to 0.6°.

8. Pipe connection as claimed in claim 1, characterized in that the screw thread of at least one of the pipe pieces has a profile height between 1.5 and 2.5 mm.

9. Pipe connection as claimed in claim 7 or 8, characterized in that each of the pipe pieces comprises between five and seven threads of the screw thread.

10. Pipe connection as claimed in claim 7, characterized in that the annular cavity is placed in a male part of the screw thread.

11. Pipe connection as claimed in claim 6 or 7, characterized in that the screw thread has a rounded profile on the outside and a rectangular profile on the inside.

12. Pipe connection as claimed in claim 10, characterized in that the profile height of the screw thread lies between 4 and 25 mm.

13. Pipe connection as claimed in claim 9, characterized in that a cylindrical part is placed connecting onto the conical part, wherein only the conical part is provided with screw thread and wherein the annular cavity lies at the transition between the conical and the cylindrical part.

14. Pipe connection as claimed in claim 11, characterized in that the external diameter of the male end is smaller than the internal diameter of the female end.

15. Pipe piece comprising a male part of a pipe connection as claimed in claim 1.

16. Pipe piece comprising a female part of a pipe connection as claimed in claim 1.

17. Method of manufacturing a pipe piece as claimed in claim 15 or 16, characterized in that fibres impregnated with a plastic are wound at a predetermined winding angle onto a rotating mandrel and the thus obtained assembly is cured in an oven.

18. Method of manufacturing a pipe connection as claimed in claim 1, characterized in that glue is applied to the screw thread of the male part of the pipe connection and in the cavity, the pipe pieces are screwed into each other and the glue connection is then cured.
